(19) United States
(12) Patent Application Publication
(10) Pub. No.: US 2012/0134547 A1
(43) Pub. Date: May 31, 2012

(54) METHOD OF AUTHENTICATING A DRIVER'S REAL FACE IN A VEHICLE

(75) Inventor: Ho Choul Jung, Yongin (KR)

(73) Assignee: HYUNDAI MOTOR COMPANY, Seoul (KR)

(21) Appl. No.: 13/090,619

(22) Filed: Apr. 20, 2011

(30) Foreign Application Priority Data
Nov. 26, 2010 (KR) 10-2010-0119182

(51) Int. Cl. G06K 9/00

(52) U.S. Cl. 382/118

(57) ABSTRACT

A method of authenticating whether a capture image is a real face of a driver in a vehicle includes first capturing an image of a driver's face with a light being turned on in a first image and with a light being turned off in a second image, respectively. Subsequent, a difference image is extracted between the first image data captured with the light being turned on and a second image data captured with the light being turned off. Then a boundary line is extracted from the difference image and a determination is made whether the boundary line is a curve or not. If the boundary line is determined to be a curve, the captured image is determined by a control unit to be the real face of the driver.

### CROSS-REFERENCES TO RELATED APPLICATIONS

Priority to Korean Patent Application Number 10-2010-0119182, Nov. 26, 2010, hereby incorporated by reference in its entirety, is claimed.

### BACKGROUND OF THE INVENTION

1. Field of the Invention

The present invention relates to a method of authenticating whether an image of a face captured is a real face of a driver in a vehicle, and more particularly, to a technology for authenticating a driver's face in a vehicle by using a reflection pattern of a light reflected from a driver's face in the vehicle.

2. Description of the Related Art

A face authentication systems refer to systems used to authenticate an individual by scanning a face of the individual.

For example, in one known face authentication system, a face of an individual is photographed to register a distinct characteristic of the individual's face as registered data. Subsequently, when the individual needs to be authenticated, the individual's face is again photographed to extract the distinct characteristic data thereof and the extracted distinct characteristic data is compared with the registered data to determine if the two faces are identical.

Typically, in this type of conventional face authentication system, eye blinks or pupil movements are used to detect counterfeiting or forgery. However, such authentication methods have low reliability due to a possibility that a photo of the registered face can be placed in front of a forgers face to manipulate the pupil movements or the eye blinks and thus trick the system into authenticating the forger.

### SUMMARY OF THE INVENTION

The present invention provides a method of extracting a difference image between image data of a driver's face photographed with a vehicle interior light being turned on and an image data of the driver's face photographed with the vehicle interior light being turned off without a separate sensor, thereby identifying whether the photographed driver's face is a driver's real face based on a boundary line of the difference image.

In accordance with one exemplary embodiment of the present invention, a method of authenticating a real face of a driver in a vehicle is provided. In this embodiment a face of the driver is captured with a light being turned on in a first image and with a light being turned off in a second image, respectively. Next, a difference image is extracted between the first image data captured with the light being turned on and the second image data captured with the light being turned off. A boundary line is then is extracted from the difference image and a determination is made whether the boundary line is a curve. In response to the boundary line being a curve, authenticating the captured face as the real face of a driver.

For example, when the boundary line is extracted from the difference image, the difference image may include binarizing the difference image; performing a labeling operation on the binarized difference image to extract a largest labeling area; removing noise in the largest labeling area; and extracting a boundary line of the largest labeling area of which noise is removed.

More specifically, removing the noise in the largest labeling area may be performed by an opening technique, which is one of one or more morphology methods, and extracting the boundary line of the largest labeling area may be performed by using a chain code technique or an edge extraction technique.

Furthermore, if the boundary line extracted is a straight line, a determination is made that the face captured the face is a photo and therefore is not a real face.

### BRIEF DESCRIPTION OF THE DRAWINGS

The objects, features and advantages of the present invention will be more apparent from the following detailed description in conjunction with the accompanying drawings, in which:

FIG. 1 is a view illustrating a configuration of a system for authenticating a driver's face within a vehicle according to an exemplary embodiment of the present invention;

FIG. 2 is a flow chart illustrating a method of authenticating whether a captured image is a driver's real face within a vehicle according to an exemplary embodiment of the present invention;

FIG. 3A is a view illustrating an example of a face image data captured with a light in FIG. 2 being turned off;

FIG. 3B is a view illustrating an example of a face image data captured with the light in FIG. 2 being turned on;

FIGS. 4A to 4E are views for explaining a method of authenticating whether a captured image is a driver's real face within a vehicle according to an exemplary embodiment of the present invention;

FIG. 5 is a view for explaining a morphology operation in FIG. 2;

FIG. 6A is a view illustrating an example in which an extracted boundary line of FIG. 2 is a curve; and

FIG. 6B is a view illustrating an example in which the extracted boundary line of FIG. 2 is a straight line.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

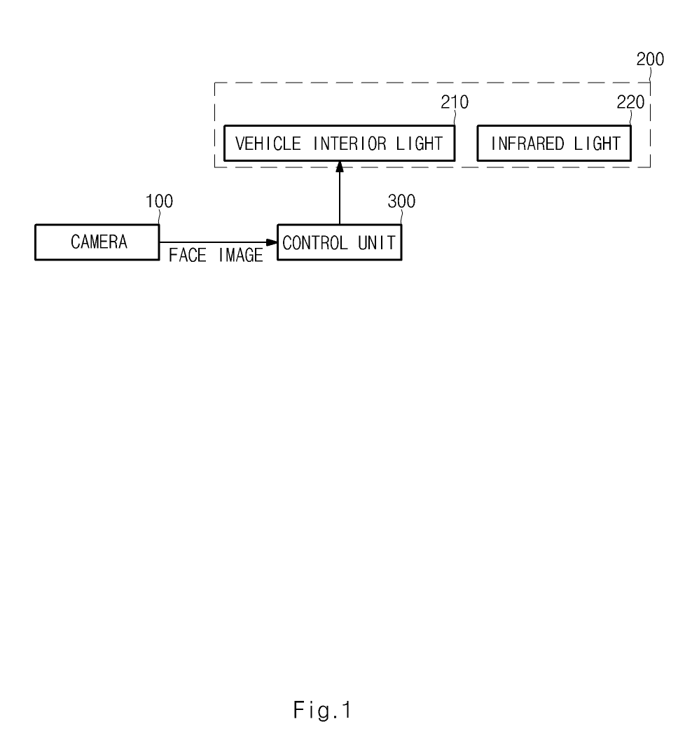

Hereinafter, a method of authenticating whether a captured image is a driver's real face in a vehicle according to an exemplary embodiment of the present invention is described with reference to FIGS. 1 to 6B.

FIG. 1 is a view illustrating a configuration of a system for authenticating whether a captured image is a driver's face within a vehicle according to an exemplary embodiment of the present invention.

The system for authenticating whether a captured image is the driver's face in the vehicle according to an exemplary embodiment of the present invention includes a camera 100, a light 200 and a control unit 300. The camera 100 captures the driver's face under a control of the control unit 300. The light 200 is turned on or turned off under the control of the control unit 300. The light 200 may be embodied as a vehicle interior light 210 and an infrared light 220.

The control unit 300 extracts and binarizes a difference image between image data captured by the camera 100 at two distinct times, and performs a labeling operation on the difference image to extract a largest labeling area. Then the control unit 300 removes noise in the largest labeling area by using, e.g., a morphology operation, and extracts a boundary line of the largest labeling area by using, for example, either a chain code technique or an edge extraction technique. Next, the control unit 300 analyzes pixel position of the boundary line to determine whether the boundary line is a curve or not. If the boundary line is the curve, the driver's face is determined to be the driver's real face. On the other hand, if the boundary line is a straight line, the driver's face is determined to be a photo rather than the driver's real face.

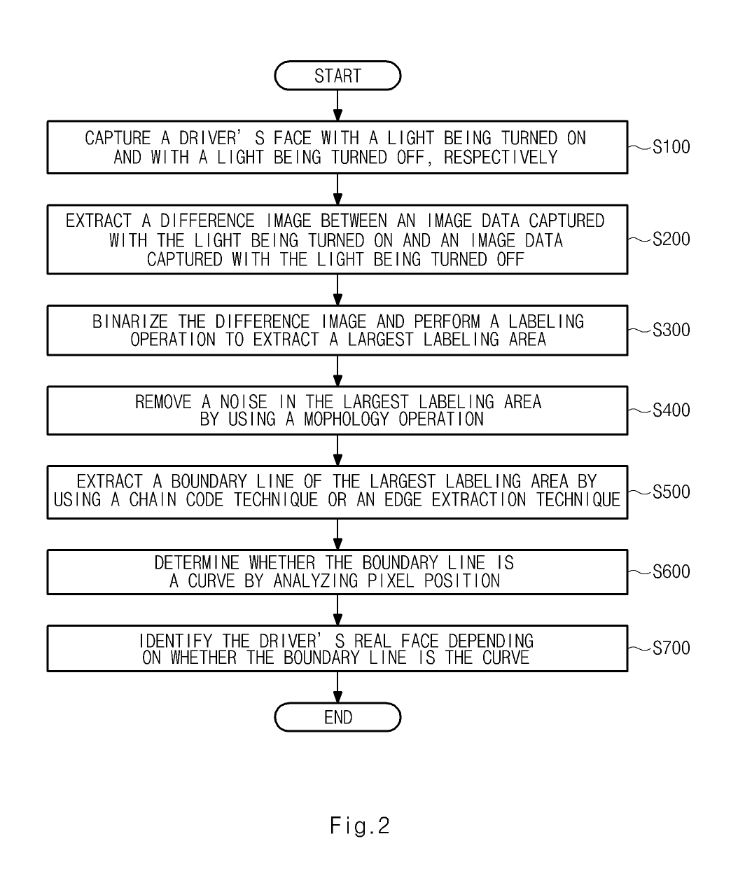

Hereinafter, referring to FIG. 2, a method of authenticating whether a captured image is a driver's real face within a vehicle according to an exemplary embodiment of the present invention is described in greater detail.

First, the control unit 300 controls the camera 100 and the light 200 to capture the driver's face with the light 200 being turned on in a first image and with the light being turned off (S100) in a second image.

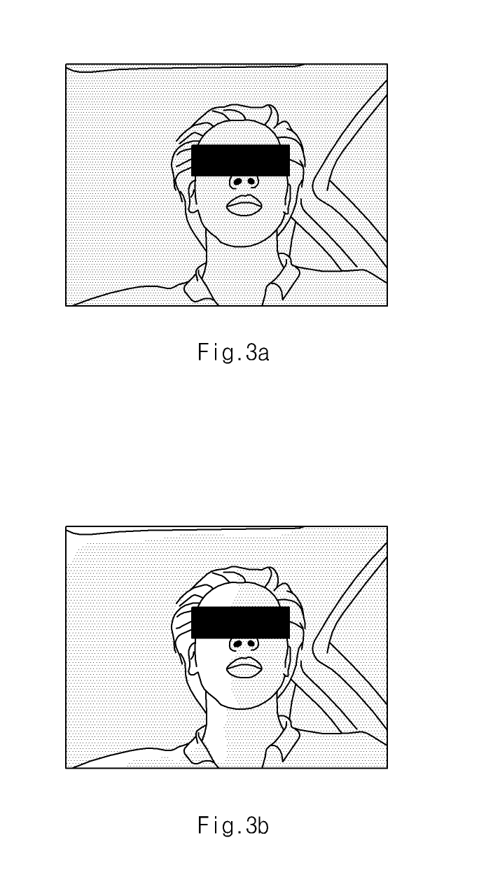

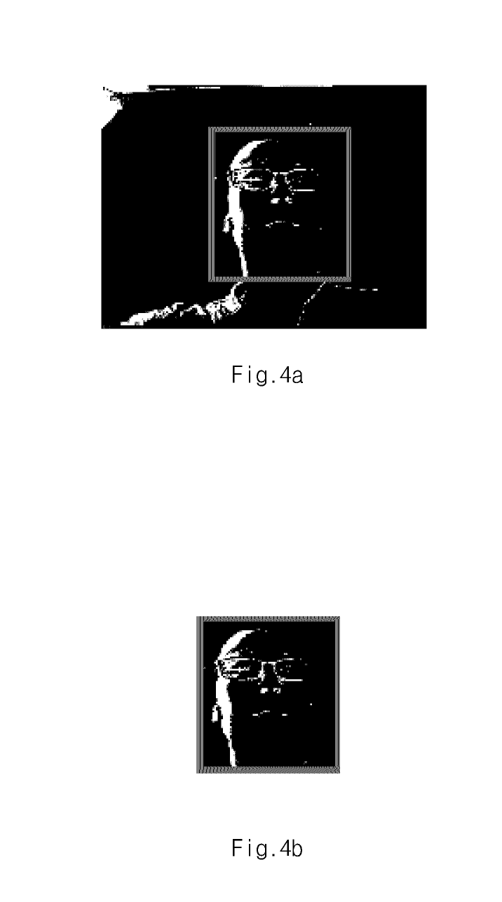

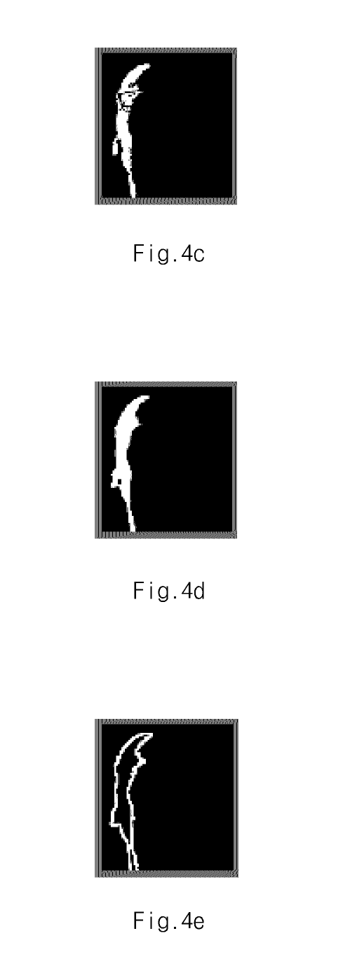

Next, the control unit 300 obtains a difference image as shown in FIG. 4A between an image data shown in FIG. 3A, which is captured with the light 200 being turned on in the first image, and an image data shown in FIG. 3B, which is captured with the light 200 being turned off in the second image (S200).

Next, the control unit 300 binarizes the difference image to recognize a boundary line that divides an object, i.e., the driver's face, from the background, extracts a facial area as shown in FIG. 4B, and performs the labeling operation (e.g., a grouping operation) on the extracted facial area to extract the largest labeling area as shown in FIG. 4C (S300).

Next, the control unit 300 removes noise in the largest labeling area by using e.g., an opening technique, which is one of morphology methods (S400). Here, the morphology operation, which is utilized for removing noise from an image or defining a shape of an object in the image, includes a dilatation operation and an erosion operation. The dilatation operation expands a bright region of the image data and the erosion operation expands a dark region of the image data.

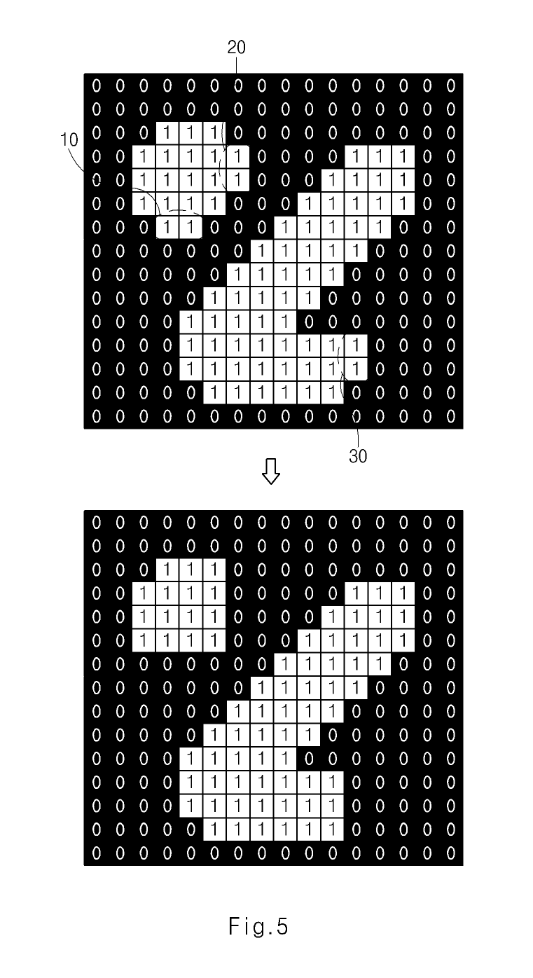

Particularly, in the opening technique among the morphology methods, the dilatation operation is followed by the erosion operation to remove small bright regions, for example, 10, 20 and 30, as shown in FIG. 5.

Next, the control unit 300 extracts the boundary line of the largest labeling area as shown in FIG. 4E by using, e.g., either the chain code technique or the edge extraction technique (S500).

Here, the chain code technique describes a boundary of an object or an area as a chain having a straight line segment of preset orientation and length and a final boundary is encoded and represented as a series of chain codes.

On the other hand, in the edge extraction technique, a pixel is compared with adjacent pixels in an image of which noise has been removed to detect an edge. If the pixel is different from the adjacent pixels by equal to or greater than a predetermined value, an edge is detected by the technique. For example, if the pixel has a difference equal to or greater than the predetermined value from an adjacent pixel, the pixel is marked as white, and if the pixel has a difference less than the predetermined value from the adjacent pixel, the pixel is marked as black, thereby representing a boundary in white.

The control unit 300 determines whether the boundary line is linear by analyzing the pixel position of the boundary line (S600) and identifies whether a captured image is a real human face depending on a linearity of the boundary line (S700).

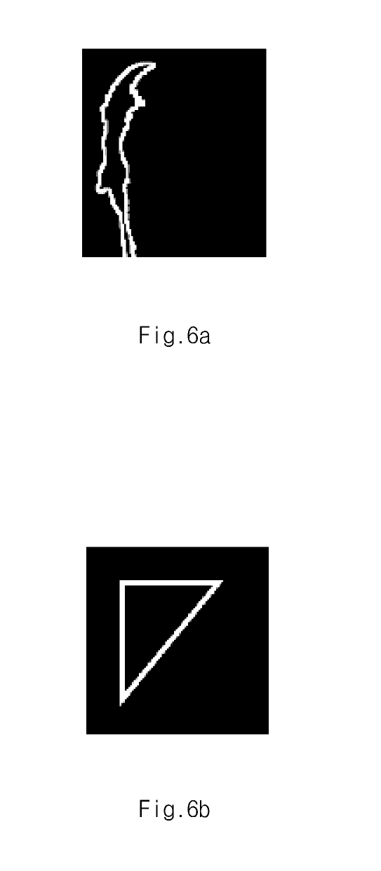

Here, the boundary line extracted from the image data obtained when capturing the real face is a curve as shown in FIG. 6A. However, the boundary line extracted from an image data obtained by capturing a photo of a face is a straight line as shown in FIG. 6B.

Accordingly, the control unit 300 is able to determine whether or not a captured image is a photographed driver's face or a real face by determining that a boundary line is a curve or a straight line.

Thus, in the present invention, a driver's face is photographed with a vehicle's light being turned on or off and the boundary line is extracted from the difference image between the image data captured with the light being turned on and the image data captured with the light being turned off, to determine whether an object captured by the camera is a driver's real face depending on whether the boundary line is a curve or a straight line.

Furthermore, in the present invention, a driver's face is authenticated by using a reflection pattern of a light reflected from the driver's face, thereby obviating a need for a separate sensor while improving efficiency of an authentication process of the driver's face.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of authenticating whether a captured face is a real face of a driver in a vehicle, the method comprising:
capturing an image of a driver's face with a light being turned on in a first image and with a light being turned off in a second image, respectively;
extracting a difference image between the first image data captured with the light being turned on and the second image data captured with the light being turned off;
extracting a boundary line from the difference image;
determining whether the boundary line is a curve; and
in response to a determining the boundary line is a curve, identifying the captured image as the real face of the driver.

2. The method of claim 1, wherein extracting a boundary line from the difference image comprises:
binarizing the difference image;
performing a labeling operation on the binarized difference image to extract a largest labeling area;
removing noise in the largest labeling area; and
extracting a boundary line of the largest labeling area of which noise has been removed.

3. The method of claim 2, wherein removing noise in the largest labeling area is performed by an opening technique, which is one of one or more morphology methods.

4. The method of claim 2, wherein extracting a boundary line of the largest labeling area is performed by a technique selected from a group consisting of a chain code technique and an edge extraction technique.

5. The method of claim 3, wherein extracting a boundary line of the largest labeling area is performed by a technique selected from a group consisting of a chain code technique and an edge extraction technique.

6. The method of claim 1, wherein identifying the real face comprises,
in response to determining that the boundary line is a straight line instead of a curve, identifying the captured image as a photo of the drivers face.

7. The method of claim 2, wherein identifying the real face comprises,
in response to determining that the boundary line is a straight line instead of a curve, identifying the captured image as a photo of the drivers face.

8. A system of authenticating whether a captured image is a real face of a driver in a vehicle, the system comprising:
A camera configured to capture an image of a driver's face with a light being turned on in a first image and with a light being turned off in a second image, respectively; and
a control unit configured to extract a difference image between the first image data captured and the second image data captured; extract a boundary line from the difference image, determine whether the boundary line is a curve, and identify the captured image as the real face of the driver in response to a determination that the boundary line is a curve.

9. The system of claim 8, wherein the control unit is further configured to binarize the difference image, perform a labeling operation on the binarized difference image to extract a largest labeling area, remove noise in the largest labeling area, and extract a boundary line of the largest labeling area of which noise is removed.

10. The system of claim 9, wherein the control unit is further configured to remove noise in the largest labeling area is performed by an opening technique.

11. The system of claim 9, wherein the extraction of the boundary line of the largest labeling area is performed by a technique selected from a group consisting of a chain code technique and an edge extraction technique.

12. The system of claim 8, wherein the control unit is further configured to identify the captured image as a photo of the drivers face in response to determining that the boundary line is a straight line instead of a curve.
